(19) United States
(12) Patent Application Publication
(10) Pub. No.: US 2018/0203143 A1
(43) Pub. Date: Jul. 19, 2018

(54) Mapping Fractures using Micro-Seismic Events

(71) Applicant: Halliburton Energy Services, Inc., Houston, TX (US)

(72) Inventors: Lee J. Hall, The Woodlands, TX (US); Travis Jay Swanson, Littleton, CO (US); Robert Ross Nellums, Littleton, CO (US)

(73) Assignee: Halliburton Energy Services, Inc., Houston, TX (US)

(21) Appl. No.: 15/317,090

(22) PCT Filed: Dec. 7, 2015
(86) PCT No.: PCT/US2015/064323

§ 371 Date: Dec. 7, 2016

(51) Int. Cl. G01V 1/28; E21B 43/263; G01V 1/104

(52) U.S. Cl. CPC G01V 1/288; E21B 43/263; G01V 2210/646; G01V 2210/1234; G01V 1/104

(57) ABSTRACT

A method and system for mapping fractures in a subterranean formation by generating micro-seismic events within fractures using energetic fracturing fluid. The micro-seismic events may be generated by injecting reactive particles and explosive particles into the fractures. A triggering event may occur that allows the reactive particles to come into contact with a fluid within the fractures, causing energetic reactions. The explosive particles may detonate from the energy generated by the reactions.

### BACKGROUND

This section is intended to provide background information to facilitate a better understanding of the various aspects of the described embodiments. Accordingly, it should be understood that these statements are to be read in this light and not as admissions of prior art.

Hydraulic fracturing is used to improve well productivity by hydraulically injecting fluid under pressure into a selected zone of a reservoir. The pressure causes the formation and/or enlargement of fractures in this zone. Proppant is typically positioned in the fractures with the injected fluids before pumping is halted to prevent total closure. The proppant thus holds the fractures open, creating a permeable and porous path, open to fluid flow from the reservoir formation to the wellbore. Recoverable fluids, such as, oil, gas or water are then pumped or flowed to the surface.

The information on the geometry of the generated hydraulic fracture networks in a given reservoir formation can be helpful in determining the design parameters of future fracture treatments (such as types and amounts of proppant or fluids to use), further well treatments to be employed, for the design of the future wells to be drilled, for managing production, etc. Therefore, there is a need for accurate mapping of the fractures. Fractures may be mapped using pressure and temperature analysis, seismic sensor (e.g., tilt-meter) observational analysis, and micro-seismic monitoring of fracture formation during fracturing processes.

### BRIEF DESCRIPTION OF THE DRAWINGS

For a detailed description of the embodiments of the invention, reference will now be made to the accompanying drawings in which:

FIG. 1 depicts a schematic of example treatment and monitoring wells with arrayed sensors for detection and recording micro-seismic events caused by energetic fracturing fluid, according to one or more embodiments;

FIG. 2 depicts a schematic of a micro-seismic particle, according to one or more embodiments;

FIG. 3 depicts a schematic of another micro-seismic particle, according to one or more embodiments;

FIG. 4 depicts a schematic of a reactive particle, according to one or more embodiments;

FIG. 5 depicts a flow chart of an example method for generating micro-seismic events within fractures in an earth formation, according to one or more embodiments;

FIG. 6 depicts a schematic of an explosive particle mixed with proppant in a fracture of an earth formation, according to one or more embodiments; and

FIG. 7 depicts a schematic of example treatment and monitoring wells with arrayed sensors for detection and recording micro-seismic events generated by energetic fracturing fluid, according to one or more embodiments.

### DETAILED DESCRIPTION

This disclosure provides embodiments of a method and system for mapping fractures within a subterranean formation. Specifically, this disclosure provides a method and system for mapping fractures by generating micro-seismic events within the earth formation using energetic fracturing fluid.

Micro-seismic events may be generated from functionalized proppant having an energetic chemistry. The energy may be released in a controlled fashion through endogenous or exogenous stimuli (e.g., one or more triggering parameters of a formation fluid or a triggering fluid injected in the formation). Reactive particles may be incorporated with functional proppant in such a way that they release a large proportion of their chemical energy as a pressure wave to ignite explosive particles injected into the fracture.

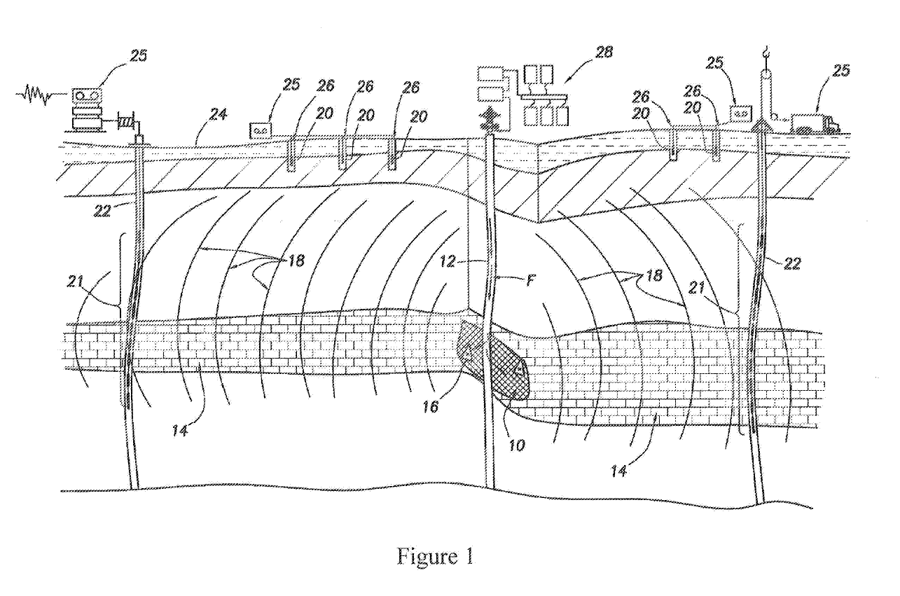

FIG. 1 depicts a schematic illustration of a system for mapping subterranean fractures in a primary well and monitoring wells with sensors arrays for acquisition, and recording of waves originating from the fracture space and traveling through the reservoir formations in accordance with one or more embodiments. In a drilling operation, several wellbores may be used in a field to maximize production of hydrocarbons. Production of hydrocarbons can be enhanced by improving flow of fluids to the producing well using hydraulic fracturing techniques. The induced and pre-existing fractures create conductive pathways into the producing wells for fluids to flow to the well bore. Fractures formed by hydraulic fracturing methods may extend from the wellbore into the reservoir rock for as much as several hundred feet. As explained above, proppant materials may be pumped into the fractures during formation to “prop” or maintain the fractures in an open, conductive state. Upon cessation of pumping, the opened or hydraulic fractures collapse or close for all practical purposes, leaving “propped fractures” open which are of smaller dimension. “Effective fractures,” meaning the fractures providing production fluid conductivity to the wellbore, are typically of even smaller dimension.

An exemplary hydraulic fracture 10 is formed by pumping a fracturing fluid (F) into the treatment well 12 at a downhole pressure sufficient to exceed the fracture gradient of the reservoir formation 14. The increased pressure causes the formation rock 14 to fracture, which allows the fracturing fluid F to enter and extend the fracture further into the formation 14. The fracturing of formation rock 14 and other events often related to expansion or relaxation of formation rock that change the in situ stress profile and pore pressure distribution create a plurality of micro-seismic events 16.

As used herein, the term “micro-seismic event” (and similar) refers to any event that causes a small but detectable change in stress and pressure distributions in a reservoir formation, including those caused by slippages, deformation, and breaking of rock along natural fractures, bedding or faults, creation of fractures or re-opening of fractures, and events artificially created by fracturing operations or caused by an explosion, implosion, exothermic reaction, etc.

Each micro-seismic event 16 generates seismic, or acoustic, waves 18. The waves generated may be of various types such as body waves, surface waves and others. For the purposes of this invention, the body waves are the main point of interest. There are two types of body waves: compression, pressure or primary waves (called P-waves), and shear or secondary waves (called S-waves). The P-waves and S-waves travel through the earth formations at speeds governed by the bulk density and bulk modulus (rock mechanical properties) of the formation. The rock mechanical properties of the formation vary according to mineralogy, porosity, fluid content, in situ stress profile and temperature.

The terms “seismic wave,” “seismic pulse,” “acoustic wave,” “acoustic pulse” and similar, as used herein, refer to detectable and measurable P- and S-waves caused by the micro-seismic event. Each type of wave may be detected and measured by corresponding sensor equipment, generally referred to herein as “seismic sensors” or “acoustic sensors” or similar.

The waves 18 propagate away from each micro-seismic event 16 in all directions and travel through the reservoir formations. These waves are detected by a plurality of seismic sensors, such as seen at 20 and 21. These sensors (or receivers), which are capable of detecting and measuring micro-seismic events, can be of any type, such as seismographs, tilt meters, piezoelectric sensors, accelerometers, transducers, ground motion sensors, multi-axis sensors, geophones and/or hydrophones. Seismic sensors and sensor arrays are commercially available and known in the industry. The seismic sensors are sensitive instruments capable of detecting micro-seismic events 16. The seismic sensors can be placed in a wellbore of one or more observation or monitoring wells 22. Sensors can also be placed at or near the surface 24, preferably in shallow boreholes 26 drilled for that purpose. A typical shallow borehole 26 for such a purpose is ten to forty feet deep.

The accuracy of mapping recorded micro-seismic events is dependent on the number of sensors spaced across the reservoir and by the distance of the sensors from the measured events. It is beneficial, therefore, to place sensors in the treatment well. The current micro-seismic monitoring methods suffer from the fact that the entire process takes place during hydraulic fracturing. Therefore the recorded data include the “noise” of the fracturing process and the results (mapped event locations) are of opened fractures (rather than propped or effective fractures).

The embodiments described herein make it possible to map the effective (propped and connected) fracture space by separating the mapping survey from fracture formation process. Further, the embodiments described herein improve the quality and accuracy of the mapping process by allowing sensors to be placed in the treatment well and without interference from hydraulic fracturing “noise.”

The recorded P- and S-wave data is analyzed, in a process referred to as “mapping” “imaging,” which calculates locations of the events in 3-dimensional reservoir space. A location information solution based on a statistical best-fit method may be used to map an event in terms of distance, elevation, and azimuth. Analysis of the recorded and measured seismic events will not be discussed herein in detail, as it is known in the art. Software for analyzing and displaying the measurements and results are commercially available. For example, such products and services are available from Halliburton Energy Services, Inc. of Carrolton, Tex., under the brand names such as FRACTRAC® and TERRAVISTA® visualization and interpretation.

Sensors 20 and 21 detect and acquire P- and S-wave data that are generated by micro-seismic events 16 and traveled through the formations. The data is typically transferred to data processing systems 25 for preliminary well site analysis. In-depth analysis is typically performed after the raw data is collected and quality-checked. After final analysis, the results (maps of the fracture networks) are used in development planning for the reservoir and field, and in designing future hydraulic fracturing jobs.

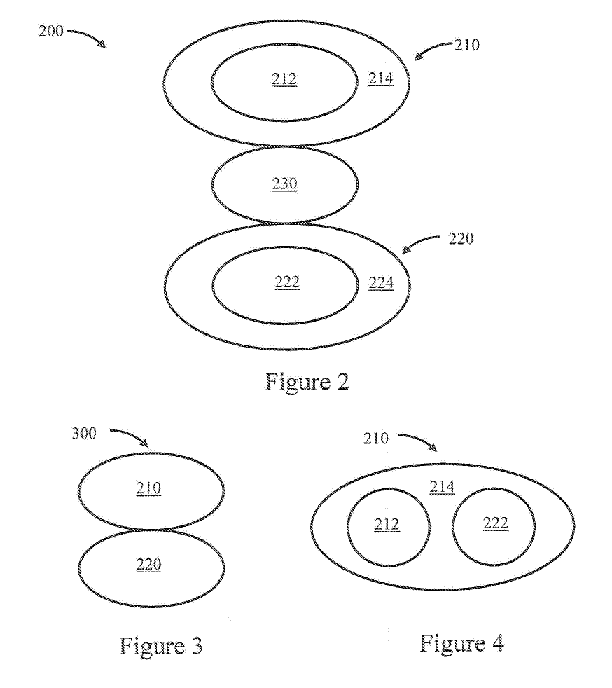

FIG. 2 depicts a schematic of micro-seismic particle 200, according to one or more embodiments. Micro-seismic particle 200 includes reactive particle 210 coupled to explosive particle 220 via adhesion particle 230. Micro-seismic particle 200 can be injected into a fracture in a subterranean formation when reactive particle 210, explosive particle 220, and adhesion particle 230 are coupled together. The adhesion particle 220 can include attachment features (such as ports, sockets, or tentacles) to bind reactive particle 210 to explosive particle 220. In other embodiments, micro-seismic particle 200 may form in the fracture by injecting reactive particle 210, explosive particle 220, and adhesion particle 230 into the formation. Reactive particle 210, explosive particle 220, and adhesion particle 230 may be injected into the fractures using a particle injection or downhole tool deployed adjacent to the fractures in a borehole intersecting the subterranean formation.

Reactive particle 210 can include shell 214, which surrounds reactive material 212. Shell 214 can include one or more decay layers (not shown) that decay on a triggering event allowing reactive material 212 to come into contact with a fluid within fractures in a subterranean formation. Reactive material 212 can react with the fluid within the fractures, releasing energy (such as a pressure wave) that detonates explosive particle 220. The detonation of explosive particle 220 may contribute to generating a micro-seismic event within the fracture.

Explosive particle 220 can include shell 224 surrounding explosive material 222. Shells 214, 224 can include attachment features (such as ports, sockets, or tentacles) configured to bind with adhesion particle 230. Shells 214, 224 can include one or more protective layers (not shown) to protect the payload (reactive material 212 or explosive material 222) of each respective particle 210, 220.

FIG. 3 depicts a schematic of micro-seismic particle 300, according to one or more embodiments. Micro-seismic particle 300 includes reactive particle 210 coupled to explosive particle 220 without an adhesion particle. The reactive particles and/or explosive particles may be configured to have many of the binding characteristics of the adhesion particles (such as ports, sockets, or tentacles). For example, the reactive particles may be configured to bind to the explosive particles without the adhesion particles. In this situation, adhesion particles may not be injected in the fractures.

FIG. 4 depicts another example of reactive particle 210 including an explosive payload. The reactive particles may be configured to carry an explosive payload, i.e., an agglomeration of the reactive particles and the explosive particles (reactive-explosive particles). Reactive particle 210 may include shell 214 that surrounds reactive material 212 and explosive material 222. Another example (not shown) of the reactive-explosive particles may include a reactive payload adjacent to an explosive payload separated by a partition on the same particle. In these situations, separate explosive particles may not be injected in the fractures. Instead, the reactive-explosive particles may be injected in the fractures to generate the micro-seismic events.

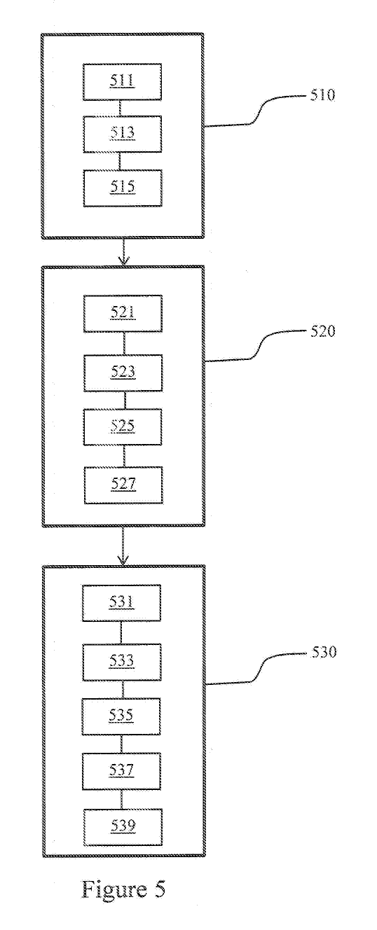

FIG. 5 is a flow chart of an example method for generating micro-seismic events within fractures in an earth formation, according to one or more embodiments. Not all of the steps of the method must be performed, nor must they be performed in the order presented. Variations are presented and discussed herein and will be recognized and understood by those of skill in the art. In FIG. 5, the process is shown divided into three stages 510, 520, and 530 indicating “fracturing,” “surveying,” and “data processing” stages, respectively. The fracturing fluid is pumped into a target zone of the formation, into existing fractures and creating additional fractures at step 511. The fracturing fluid contains or delivers proppant particles to prop open the fractures. Also at step 511, adhesion particles, additives, tracers (e.g., chemical or radioactive), other substances, or combinations thereof may be mixed with the proppant and injected into the fractures. At step 513, pumping operations are ceased. Also at this step, open fractures typically close, except where the proppant and/or adhesion particles have been placed in the fracture space. Optionally, there may be a “clean-out” step 515, during which fracturing fluid may be allowed to flow-back, to clean the fracturing fluids from the reservoir formations.

At step 521, a particle injection or downhole tool is deployed adjacent the zone of interest and reactive particles (e.g., reactive particles having a reactive material comprising magnesium and silver nitrate) are injected into the zone using the downhole tool. The reactive particles travel in the fracture space and may attach to adhesion particles (if present). At step 523, explosive particles (e.g., explosive particles having an explosive material comprising lead azide) are injected into the zone and attach to either the adhesion particles, reactive particles, or both. Also at steps 521 or 523, adhesion particles, additives, tracers (e.g., chemical or radioactive), other substances, or combinations thereof may be mixed with the reactive particles or explosive particles and injected into the fractures. In other embodiments, the reactive particles, explosive particles, adhesion particles, additives, tracers, other substances, or combinations thereof can be injected with the proppant at step 511 with or without separate particle injection steps 521 and 523. At step 525, a triggering event occurs, allowing or causing contact between the reactive particles and a fluid within the fractures, activating a reaction between the reactive particles and the fluid within the fractures to generate energy. At step 527, the explosive particles are detonated by the energy generated from the reactions, causing micro-seismic waves to travel in all directions throughout the formation. In embodiments, fracturing fluid including proppant, reactive particles, explosive particles, adhesion particles, additives, tracers, other substances, or combinations thereof may be injected into the fractures to generate micro-seismic events according to the methods described herein.

At step 531, the micro-seismic events (or the waves thereof) are detected by sensors. Signals indicative of the micro-seismic events are received by sensors. Various stages of data processing of the signals follows, such as recording, transfer, filtering, clean-up, quality-check, etc., (step 533). Other steps can include preliminary field processing (step 535), transfer to data processing centers (step 537), and final processing and output for fracture mapping (step 539). A processor may be configured to perform all or part of the data processing stages 530.

All or part of the surveying 520 and data processing 530 stages may be repeated at a later time using other species of the reactive particles, adhesion particles, explosive particles, or the fluid within the fractures, to provide a second fracture mapping survey or allowing a “time-lapse” capability.

The reactive particles may include a reactive material that reacts with a water-based fluid to release energy in the form of a pressure wave that ignites the explosive particles or initiates an explosion of the explosive particles. The reactive particles may release this volume-pressure energy after coming into contact with a fluid (such as fluid including water) within the fractures. The reactive particles can be configured to activate reactions between the reactive material and a fluid. The reactive material may include (a) an organometallic material, (b) a carbide, (c) a nitride, (d) a silicide, (e) an azide, (f) a phosphide, (g) a hydride, (h) a metallic material, (i) a pyrophoric material, (j) a material including a fuel particle and an oxidizer particle, or (k) combinations thereof. As non-limiting examples, the reactive particles may be selected from these examples in Tables 1-5:

TABLE 1
Fuels + Oxidizers

| Chemistry | Reactive Particles |
|---|---|
| Al + I₂ | Aluminum Iodine |
| B + AgF₂ | Boron + Silver Difluoride |
| KClO₄ + Sugar + | Potassium Perchlorate + Sugar + Mercury |
| Hg(CNO)₂ + H₂SO₄ | Fulminate + Acid |
| Mg + AgNO₃ | Magnesium + Silver Nitrate |
| Mg + AgF₂ | Magnesium + Silver Difluoride |
| Mg + BaO₂ | Magnesium + Barium Peroxide |
| Mg + CerAN | Magnesium + Ceric Ammonium Nitrate |
| Mg + I₂ | Magnesium Iodine |
| Mg + I₂O₅ | Magnesium + Iodopentoxide |
| Na₂O₂ + Na₂S₂O₃ | Sodium Peroxide + Sodium Thiosulfate |
| NaClO₄ + Sugar + H₂SO₄ | Sodium Perchlorate + Sugar + Sulfuric |
| | Acid |
| Zn + I₂ | Zinc Iodine |

TABLE 2
Organometallic Materials

| Chemistry | Reactive Particles |
|---|---|
| Al(C₆H₅)₃ | Triphenylaluminum |
| B₃Cl₃H₃N₃ | Trichloroborazine |
| In(CH₃)₃ | Trimethyl Indium |

TABLE 3
Carbides, Nitrides, and Silicides

| Chemistry | Reactive Particles |
|---|---|
| BaC₂ | Barium Carbide |
| BiN | Bismuth Nitride |
| CeN | Cerium Nitride |
| K₂SN₂ | Dipotassium Sulfur Diimide |

TABLE 4
Metals and Pyrophorics

| Chemistry | Reactive Particles |
|---|---|
| BaO₂ | Barium Peroxide |
| BI₃ | Boron Triiodide |
| C₂Cl₆ | Hexachloroethane |
| Ca + Si + Mn | Pyrophoric Alloy |
| K | Potassium |
| Na | Sodium |
| Rb | Rubidium |
| TiCl₂ | Titanium Dichloride |

TABLE 5
Azides, Phosphides, and Hydrides

| Chemistry | Reactive Particles |
|---|---|
| KN₃O₆S | Potassium Azidodisulfate |
| LiAlH₄ | Lithium Aluminum Hydride |
| NaAlH₄ | Sodium Aluminum Hydride |
| Zn₃P₂ | Zinc Phosphide |

Processing methodologies that may be used to prepare or form these reactive particles may include, but are not limited to these examples: resonant acoustic mixing (e.g., LabRAM Mixer available from RESODYN® Acoustic Mixers, Inc., of Butte, Mont.) as a baseline mixing method; coacervation of oxidizing components or binders onto metal fuel particles to precipitate agglomeration or granulation; arrested reactive milling (ARM) to enhance sensitivity and boost output; and low-energy ball milling (roller or otherwise) for granulation, agglomeration, or densification. It should be appreciated that other methodologies suitable for preparing reactive particles may be used as well.

The reaction between the reactive particles and the fluid within the fractures may occur upon a triggering event, such as endogenous or exogenous stimulus within the fractures, or combinations of the two stimuli. The reactive particles may include one or more decay layers that are dissipated, by heat, time, pressure, pH, or salinity based on the endogenous or exogenous stimulus. The triggering event may include multiple stages, such as a decay stage for removing decay layers from the particles. The decay stage may, for example, include methods such as injecting a fluid (brine, acid, chemical wash, etc.) into the formation to dissolve or otherwise remove any decay layers. The decay stage may employ a change in an environmental condition such as temperature, pressure, salinity, pH, etc., of a formation fluid or a triggering fluid. For example, high salinity water may be injected into the fractures to dissolve one or more decay layers on one or more particles, thereby triggering a reaction between the now-exposed core section of the reactive particle and the fluid within the fractures. As another example, the decay layers may dissolve from the salinity of the formation fluid within the fracture. Alternatively, the triggering event may simply be a time delay during which the decay layers dissipate and/or coalesce allowing the reactive particles to come into contact and/or to mix with the fluid, thereby initiating the reaction.

The endogenous stimulus may occur when a triggering parameter of a formation fluid reaches a pre-determined value. The triggering parameter of the formation fluid may include at least one of temperature, pressure, pH, salinity, and any other parameter of the formation fluid that may dissipate the decay layer and allow the reactive particles to come into contact with the formation fluid. In embodiments, the formation fluid may include any fluid existing in the formation before other fluids are injected in the formation.

The exogenous stimulus may occur when a triggering parameter of a triggering fluid reaches a pre-determined value. The triggering parameter of the triggering fluid may include at least one of temperature, pressure, pH, salinity, and any other parameter of the triggering fluid that may dissipate the decay layer and allow the reactive particles to come into contact with the triggering fluid. In embodiments, the triggering fluid may include any fluid that is injected into the formation.

Multiple species of explosive particles and combinations thereof may be used to generate the micro-seismic events. As examples, the explosive particles may include an energetic material, including but not limited to (a) hexamethylene triperoxide diamine, (b) lead (II) azide, (c) lead styphnate, (d) silver azide, (e) sodium azide, (f) mercury fulminate, or (g) combinations thereof. The explosive particles may include an energetic material that is sensitive to detonation by a pre-determined amount or intensity of heat, friction, kinetic impact, electric shock, or electromagnetic radiation. The energetic material of the explosive particles may be selected to be sensitive to explode or detonate from the energy released by the reactions between the reactive particles and the fluid within the fractures. For example, the explosive particles may be selected to be sensitive to explode or detonate from the impact of a pressure wave released by the reaction.

The relatively low content of ductile metals in binary systems may use adhesion particles (e.g., binders or processing agents) to improve particle-to-particle adhesion between the reactive particles and the explosive particles, the fuel particles and the oxidizer particles of the reactive particles, or any combinations of the reactive particles, explosive particles, fuel particles, and oxidizer particles. Multiple species of adhesion particles may be used. As non-limiting examples, the adhesion particles may include polyvinyl alcohol, polyvinylpyrolidone, polyvinyl butyral, hexafluoropropylene (HFP), vinylidene fluoride (VDF), and tetrafluoroethylene (TFE), carbon nanotubes, benzonitrile, acetonitrile, or combinations thereof.

The adhesion particles, reactive particles, and explosive particles may be configured to have a particle density that is substantially similar to the density of a proppant particle. Also, the adhesion particles, reactive particles, and explosive particles may be configured to have a particle shape that is substantially similar to the shape of a proppant particle. This is to increase the probability that the reactive particles and explosive particles penetrate the fractures to the same extent as the proppant. In other words, as the reactive particles and explosive particles approach the same density and/or shape of the proppant, these particles may penetrate the proppant bed, allowing the particles to generate micro-seismic events in this zone. This leads to a more accurate image of the dimensions of the propped fracture itself.

The adhesion particles, reactive particles, and explosive particles may be of any suitable size, shape, or density to fit the fracture space and to contain required amounts of materials suitable to generate micro-seismic events within the fractures. By substantially similar density, it is meant that the density of the particle is within ±5% of the density of a proppant. By substantially similar shape, it is meant that at least one dimension of the particle (e.g., height, width, depth, radius, perimeter, surface area, or volume) is within ±5% of the same dimension of the proppant.

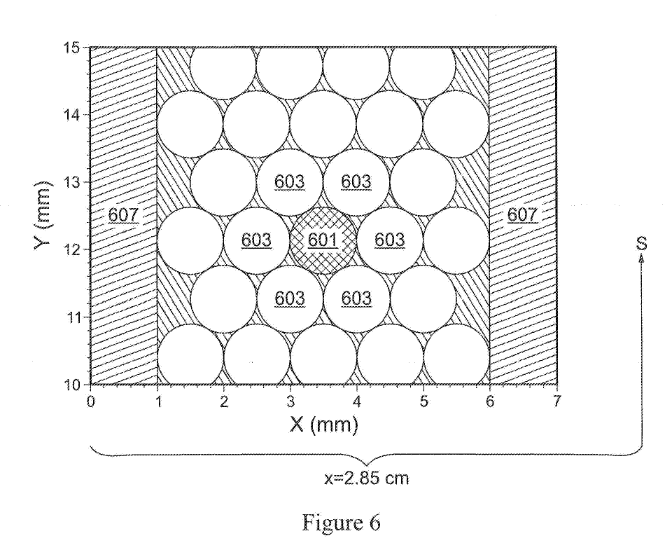

FIG. 6 depicts a schematic of explosive particle 601 mixed with proppant 603 and fracturing fluid 605 in fracture 607 of an earth formation to model the pressure coupling generated by the detonation of explosive particle 601, according to one or more embodiments. In simulations, proppant 603 and explosive particle 601 are spherical particles, hexagonally packed within fracture 607. Further, fracture 607 is modeled as limestone having a density of 2.6 g/cc, a bulk modulus of 5 Mpsi, an effective stress fracture model that approximates limestone, and an overburden pressure of 3,500 psi. Fracture 607 has fracture walls separated by about 5 mm with the center located at x=3.5 mm as illustrated. Proppant 603 is modeled as fused quartz having a pressure-shear-damage model approximating granite. Fracturing fluid 605 is modeled as water. Explosive particle 601, proppant 603, and fracturing fluid 607 are at a fracture pressure of about 5,500 psi inside fracture 607. The two-dimensional fracture space modeled encompasses 3.1 cm in the x-direction by 2.5 cm in the y-direction. FIG. 6 only shows a fraction of the modeled fractured space. The modeled cell size within the fracture space is 0.05 mm by 0.05 mm.

In a baseline simulation, energetic particle 601 is made entirely of trinitrotoluene (TNT) without any reactive material. Energetic particle 601 and proppant 603 have diameters of 1 mm. In the baseline simulation, a single energetic particle 601 is detonated in its center and positioned in the center of fracture 607 surrounded by proppant 603 as illustrated in FIG. 6, producing an extremum pressure differential (EPD) of 210 MPa. To gauge the micro-seismic event generated by explosive particle 601, the EPD is defined as the peak-to-peak swing in calculated pressure measured at simulated sensor point S at a distance of 25 mm to the right of the fracture centerline (i.e., x=2.85 cm).

Table 6 shows the effects on the pressure coupling relative to the baseline simulation according to 11 different simulation scenarios:

TABLE 6
Simulation Results

| Sim. | | Effect on Pressure | Δ in EPD |
|---|---|---|---|
| No. | Model Parameter | Coupling | vs. Baseline |
| 1 | 2.5 mm proppant | Increase | 143 MPa |
| 2 | Full slip (no shear) | Negligible Increase | 32 MPa |
| 3 | Energetic inner wall | Negligible Increase | 16 MPa |
| 4 | Energetic outer wall | Increase | 239 MPa |
| 5 | Settled proppant, surface | Negligible Decrease | −11 MPa |
| 6 | Settled proppant, buried | Slight Increase | 60 MPa |
| 7 | 0.9 mm proppant (0.1 mm | Slight Increase | 136 MPa |
| | water gap) | | |
| 8 | Outside detonation | Decrease | −79 MPa |
| | propagation | | |
| 9 | Inside detonation | Increase | 146 MPa |
| | propagation | | |
| 10 | Lead Azide, Energetic | Increase | 139 MPa |
| | Particle | | |
| 11 | Simulations 4 and 9 | Increase | 330 MPa |

In all the simulations except for simulation 10, energetic particle 601 is made entirely of TNT. In all the simulations except for simulations 8, 9, and 11, a single energetic particle 601 is detonated in its center. In simulations 8, 9, and 11, a single energetic particle 601 is detonated from one of its edges, producing a pressure wave that travels either away from or towards simulated sensor point S (x=2.85 cm). Energetic particle 601 and proppant 603 have diameters of 1 mm, except for simulations 1 and 7 where the diameter of proppant 603 varies.

In simulation 1, the diameter of proppant 603 is increased to 2.5 mm, producing an EPD of 540 MPa. In simulation 2, proppant 603 is modeled being frictionless, producing an EPD of 242 MPa. In simulation 3, energetic particle is shifted to the left to be in contact with the inner fracture wall at x=1 mm, producing an EPD of 226 MPa. In simulation 4, energetic particle is shifted to the right to be in contact with the outer fracture wall at x=6 mm, producing an EPD of 449 MPa.

In simulations 5 and 6, proppant 603 is modeled as settled in the simulated fracture space, having proppant layers that only reach about y=1.2 cm. In simulation 5, explosive particle 601 is at the surface of the settled proppant (i.e., on the top layer), producing an EPD of 199 MPa. In simulation 6, explosive particle is buried in the settled proppant having about four layers of proppant 603 above energetic particle 601, producing an EPD of 270 MPa.

In simulation 7, the diameter of proppant 603 is reduced to 0.9 mm with a 1 mm gap of fracturing fluid 605 (e.g., water) between each proppant particle, producing an EPD of 346 MPa. In simulation 8, energetic particle 601 is detonated on its right edge (i.e., at x=4 mm), producing a detonation wave traveling away from the simulated sensor point S and an EPD of 131 MPa. In simulation 9, energetic particle 601 is detonated on its left edge (i.e., x=3 mm), producing a detonation wave traveling towards the simulated sensor point S and an EPD of 356 MPa. In simulation 10, the explosive material filling explosive particle 601 is replaced with 2.47 mg of lead azide, producing an EPD of 349 MPa. In simulation 11, energetic particle 601 is positioned to be in contact with the outer fracture wall at x=6 mm and energetic particle 601 is detonated on its left edge (i.e., x=3 mm), producing an EPD of 540 MPa. As shown in Table 6, the model parameters applied in simulation 11 produce the greatest increase to the pressure coupling with relation to the baseline simulation. Further, simulation 10 demonstrates that lead azide can be used as a suitable explosive material in explosive particles to generate micro-seismic events for mapping fractures.

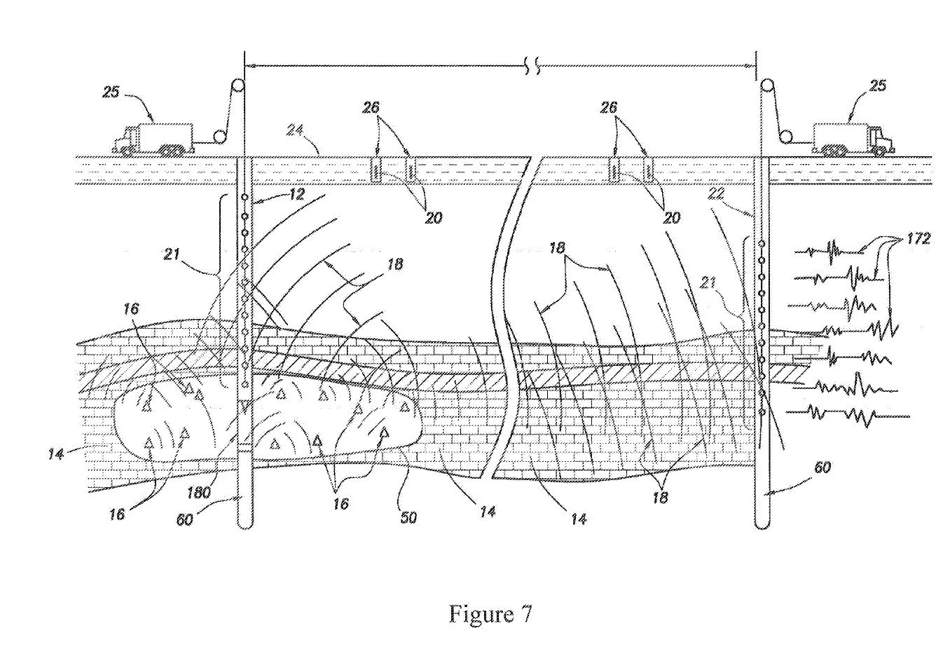

FIG. 7 depicts one or more embodiments of a schematic view of treatment and monitoring wells with arrayed sensors for detecting and recording micro-seismic events caused during hydraulic fracturing according to one or more embodiments. An effective fracture 50 has been formed in treatment well 12 in formation 14. Micro-seismic events 16 are caused according to the embodiments described herein to generate seismic waves 18. The waves 18 propagate away from each micro-seismic event 16 and travel through the reservoir formation. The waves are detected by a plurality of seismic sensors, such as seen at 20 and 21. The seismic sensors can be placed in a wellbore of one or more observation or monitoring wells 22. Sensors can also be placed at or near the surface 24, preferably in shallow boreholes 26 drilled for that purpose. Sensors 20 and 21 detect P- and S-wave data 172 from micro-seismic events 16. The data is typically transferred to data processing systems 25 for preliminary well site analysis. In-depth analysis is typically performed after the raw data is collected and quality-checked. After final analysis, the results (maps of the fracture networks) may be used in development planning for the reservoir and field, and in designing future hydraulic fracturing jobs.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to. . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A method of mapping fractures in a subterranean formation by generating micro-seismic events within the fractures, the formation having a borehole therethrough, the method comprising:
injecting reactive particles into the fractures;
injecting explosive particles into the fractures;
activating reactions between the reactive particles and a fluid within the fractures; and
detonating the explosive particles from energy generated by the reactions to generate the micro-seismic events within the fractures.

2. The method of claim 1, further comprising:
receiving signals indicative of the micro-seismic events using sensors; and
mapping the fractures using the signals.

3. The method of claim 1, wherein the reactive particles comprise at least one of: (a) an organometallic material, (b) a carbide, (c) a nitride, (d) a silicide, (e) an azide, (f) a phosphide, (g) a hydride, (h) a metallic material, (i) a pyrophoric material, and (j) a material comprising a fuel and an oxidizer.

4. The method of claim 1, further comprising injecting proppant and a fracturing fluid into the fractures.

5. The method of claim 1, wherein the explosive particles comprise lead azide and the reactive particles comprise magnesium and silver nitrate.

6. The method of claim 1, wherein the fluid comprises water.

7. The method of claim 1, further comprising increasing adhesion between the reactive particles and the explosive particles by injecting adhesion particles into the fractures.

8. The method of claim 7, wherein the adhesion particles include at least one of: (a) polyvinyl alcohol, (b) polyvinylpyrolidone, (c) polyvinyl butyral, (d) hexafluoropropylene (HFP), (e) vinylidene fluoride (VDF), (f) tetrafluoroethylene (TFE), (g) carbon nanotubes, (h) benzonitrile, and (i) acetonitrile.

9. The method of claim 1, further comprising selecting a density of at least one reactive particle to be substantially similar to a density of a proppant particle.

10. The method of claim 1, further comprising triggering the reactions between the reactive particles and the fluid with at least one of an endogenous stimulus and an exogenous stimulus.

11. The method of claim 10, wherein the endogenous stimulus comprises at least one of a pre-determined temperature of a formation fluid, a pre-determined pressure of the formation fluid, a pre-determined pH of the formation fluid, and a pre-determined salinity of the formation fluid.

12. The method of claim 10, wherein the exogenous stimulus comprises at least one of a pre-determined temperature of a triggering fluid, a pre-determined pressure of the triggering fluid, a pre-determined pH of the triggering fluid, and a pre-determined salinity of the triggering fluid.

13. The method of claim 1, wherein the fluid within the fractures comprises at least one of formation fluid and triggering fluid.

14. The method of claim 1, wherein the explosive particles comprise at least one of: (a) hexamethylene triperoxide diamine, (b) lead (II) azide, (c) lead styphnate, (d) silver azide, (e) sodium azide, and (f) mercury fulminate.

15. The method of claim 1, wherein the energy generated by the reactions is pressure waves.

16. A fracturing fluid, comprising:
reactive particles comprising a reactive material and configured to activate reactions between the reactive material and a fluid; and
explosive particles configured to detonate from energy generated by the reactions.

17. The fracturing fluid of claim 16, wherein:
the reactive particles comprise at least one of: (a) an organometallic material, (b) a carbide, (c) a nitride, (d) a silicide, (e) an azide, (f) a phosphide, (g) a hydride, (h) a metallic material, (i) a pyrophoric material, and (j) a material comprising a fuel and an oxidizer; and
the explosive particles comprise at least one of: (a) hexamethylene triperoxide diamine, (b) lead (II) azide, (c) lead styphnate, (d) silver azide, (e) sodium azide, and (f) mercury fulminate.

18. The fracturing fluid of claim 16, further comprising at least one of adhesion particles and proppant.

19. A system for mapping fractures in a subterranean formation by generating micro-seismic events within the fractures, the formation having a borehole therethrough, comprising:
fracturing fluid comprising reactive particles and explosive particles and configured to generate micro-seismic events within the fractures;
a downhole tool configured to inject the fracturing fluid into the fractures and locatable in the borehole;
a sensor configured to receive signals indicative of micro-seismic events generated by the fracturing fluid; and
a processor configured to map fractures within the formation using the signals.

20. The system of claim 19, wherein:
the reactive particles comprise at least one of: (a) an organometallic material, (b) a carbide, (c) a nitride, (d) a silicide, (e) an azide, (f) a phosphide, (g) a hydride, (h) a metallic material, (i) a pyrophoric material, and (j) a material comprising a fuel and an oxidizer; and
the explosive particles comprise at least one of: (a) hexamethylene triperoxide diamine, (b) lead (II) azide, (c) lead styphnate, (d) silver azide, (e) sodium azide, and (f) mercury fulminate.
